(19) United States
(12) Patent Application Publication
(10) Pub. No.: US 2012/0180927 A1
(43) Pub. Date: Jul. 19, 2012

(54) METHOD FOR MANUFACTURING THE BODY OF BABY CARRIERS, CARRYCOTS AND THE LIKE

(75) Inventor: Manuel JANE SANTAMARIA, Palau de Plegamans (ES)

(73) Assignee: Jane, S.A., Palau de Plegamans (ES)

(21) Appl. No.: 13/351,067

(22) Filed: Jan. 16, 2012

(30) Foreign Application Priority Data
Jan. 18, 2011 (ES) 201130051

(51) Int. Cl. B23P 17/04; B29C 67/00; B32B 37/00; B23P 11/00; B32B 37/12

(52) U.S. Cl. 156/60; 29/527.1; 29/525.12; 264/259

(57) ABSTRACT

A method includes a first stage manufacturing a first receptacle that is lightweight, corresponding to the inner part of the body. In a second stage a second receptacle is manufactured, that is resistant, corresponding to the outer part of the body. In a third stage the first receptacle is attached to the second receptacle, and they are joined peripherally by the edges of the mouths thereof. The first receptacle is to be manufactured advantageously by extruding a foamy material, and the second receptacle by injecting a resin with fibre glass. And the attachment between the first and the second receptacles is made with any conventional system.

This application claims benefit of Serial No. 201130051, filed 18 Jan. 2011 in Spain and which application(s) are incorporated herein by reference. To the extent appropriate, a claim of priority is made to each of the above disclosed applications.

### BACKGROUND OF THE INVENTION

Today manufacturing the body of baby carriers and the like is carried out by producing a receptacle generally by injecting plastic material where there are attached the pieces that are to make up the inner parts, the bottom and the details that are to form the inside of the body, and this is an expensive manufacturing process obtaining the various parts separately and carrying out the operations for attaching the inner parts inside the receptacle.

### SUMMARY OF THE INVENTION

An object of this invention is a method for manufacturing the body of baby carriers and the like that is very simple, obtaining a body with reduced weight and in one piece and which does not require additional assembly, as all that is necessary is integrated in the part constituting the body.

This manufacturing method consists of three stages, in the first stage a first receptacle is manufactured, that is lightweight, corresponding to the inner part of the body, in the second stage a second receptacle is manufactured, that is resistant, corresponding to the outer part of the body, and in the third stage the first receptacle is attached on to the second receptacle and they are joined peripherally by the edges of the mouths thereof.

The first receptacle, can be manufactured by extruding foamy material, such as “porexpan”, and the second receptacle by injecting a resin, such as polycarbonate, with fibre glass.

The attachment between the first and the second receptacles can be made using various systems such as gluing, welding, screwing or by inserting one of the receptacles into the mould of the other receptacle during the manufacturing thereof.

The body of the thus manufactured baby carrier has optimum shock absorbency in the event of a collision thanks to energy absorption, great rigidity thanks to the volumetric manufacturing system, and it is compact and very stable.

These and other characteristics will be appreciated further from the detailed description provided below, and to facilitate comprehension a sheet of drawings is attached illustrating a practical embodiment provided merely as a non-limiting example of the scope of this invention.

### DESCRIPTION OF THE DRAWINGS

FIG. 1 illustrates a perspective view of the first receptacle, corresponding to the inner part of the body of a baby carrier,

FIG. 2 illustrates a perspective view of the second receptacle, corresponding to the outer part of the body of a baby carrier, and

FIG. 3 illustrates a perspective view of the body of the baby carrier obtained with the method that is the object of the invention.

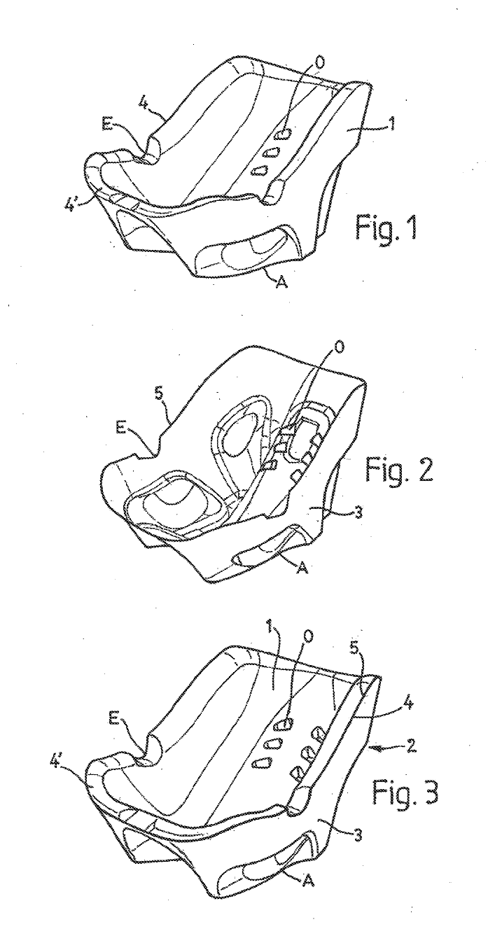

### DESCRIPTION OF A PREFERRED EMBODIMENT

According to the drawings, the method for manufacturing the body of the baby carrier and the like consists in manufacturing a first receptacle (1), obtained by extruding a foamy material such as “porexpan”, which will form the inner part of the body (2) of the baby carrier.

In the method the manufacturing of a second receptacle (3) is carried out, said receptacle being obtained by injecting a resin, such as polycarbonate, with fibre glass, which will form the outer part of the body (2) of the baby carrier.

Continuing the manufacturing process, then the first receptacle (1) is attached on to the second receptacle (3) and they are joined peripherally by the edges of the mouths thereof (4 and 5) (FIG. 3), using any suitable means such as for example gluing, or welding, or screwing, or also by inserting one of the receptacles into the mould of the other receptacle during the manufacturing thereof. For this union, the edge of the mouth (4) of the first receptacle (1) is to have on its contour a flange (4′) that is to be applied to the edge of the mouth (5) of the second receptacle (3).

According to the resistance required for the baby carrier, the two receptacles, which generally appear quite similar, are to have the relevant structure and design details such as the holes (O) in the back rest area for passing through the belts for holding the child, the lower supports (A), and the side holes (E) for passing through the seat belt for fastening the baby carrier to the car seat.

The obtained baby carrier body is to be completed with the conventional accessories such as applying a headrest, upholstery, and adding a handle for the transport thereof, and it is to have the necessary means for coupling it to a platform provided with isofix anchorage means for fixing the baby carrier on to a car seat.

The invention, within the essential nature thereof, can be implemented in other embodiments which only differentiate in detail from the one provided as an example, and which are to be equally protected. So, this method can be applied to manufacture the body of baby carriers, carrycots and the like, with the most suitable means and materials and with the most convenient accessories, as all are included within the scope of the claims.

1. Method for manufacturing the body of baby carriers, carrycots and the like, comprising:
manufacturing in a first stage a first receptacle that is lightweight, corresponding to an inner part of said body;
in a second stage a second receptacle which is resistant, corresponding to an outer part of the body;
and in a third stage attaching the first receptacle to the second receptacle, and wherein the first receptacle and the second receptacle are joined peripherally by the edges of mouths thereof.

2. Method for manufacturing the body of baby carriers, carrycots and the like, according to claim 1, wherein the first receptacle is manufactured by extruding a foamy material.

3. Method for manufacturing the body of baby carriers, carrycots and the like, according to claim 1, wherein the second receptacle is manufactured by injecting a polycarbonate resin with fibre glass.

4. Method for manufacturing the body of baby carriers, carrycots and the like, according to claim 1, wherein the attachment between the first and the second receptacle is made by gluing.

5. Method for manufacturing the body of baby carriers, carrycots and the like, according to claim 1, wherein the attachment between the first and the second receptacles is made by welding.

6. Method for manufacturing the body of baby carriers, carrycots and the like, according to claim 1, wherein the attachment between the first and the second receptacles is made by inserting one of the receptacles into a mould during the manufacturing of the other of the receptacles.

7. Method for manufacturing the body of baby carriers, carrycots and the like, according to claim 1, wherein the attachment between the first and the second receptacles is made by screwing.
